(19) United States
(12) Patent Application Publication
(10) Pub. No.: US 2024/0383059 A1
(43) Pub. Date: Nov. 21, 2024

(54) THIN CUTTING DIAMOND CHAIN SAW AND A CORRESPONDING BAR

(71) Applicant: TOOLGAL-INDUSTRIAL DIAMOND TOOLS LTD, Deganya Alef (IL)

(72) Inventors: Gadi RABINOVICH, Deganya Alef (IL); Itzick SHEFFER, Deganya Alef (IL)

(21) Appl. No.: 18/317,681

(22) Filed: May 15, 2023

(51) Int. Cl. B23D 61/18

(52) U.S. Cl. CPC B23D 61/18; B28D 1/082; B28D 1/088

(57) ABSTRACT

This invention relates to a thin cutting diamond chain saw and a guide bar corresponding to the thickness of the chain, adapting the guide bar with a new Nose Roller (guide bar edge) to dedicated wall cutting machines.

### FIELD OF THE INVENTION

This invention relates to a thin cutting diamond chain saw and a guide bar corresponding to the thickness of the chain, adapting the guide bar with a new Nose Roller (guide bar edge) to dedicated wall cutting machines.

### BACKGROUND OF THE INVENTION AND PRIOR ART

A diamond chain saw basically includes 4 components—a dedicated machine, a guide bar, a chain, which includes a steel chassis and segments made off industrial diamonds sintered into a metal matrix, and a sprocket correlating between the three elements (a kind of torque exchanger).

The chain is the cutting part and includes a steel chassis, similar to a gardening chain's one, on which diamond teeth are welded, (hereinafter “segments”).

The guide bar is the part on which the chain moves and is usually composed of three hardened steel plates with the middle plate having grooves to enable transport cooling water from the machine to the chain and the cut stone, because all diamond chain saws must work with cooling water. To-date, the guide bar's usual thickness is about 5 mm, and the thickness of the chain segments are between 5.5 mm to 6 mm. In this invention the segments' thickness is under 4.3 mm, whereas at the end of each guide bar there is a rotating gear, allowing the chain saw to rotate without unnecessary abrasion, (hereinafter “Nose Roller” NR).

The diamond chain saws, which work mainly in the field of wall sawing, serve mostly as a complement to cutting walls operations. Their use is much more expensive (diamond chains saws are much more expensive than the circular walls chain saws in use), and therefore will be used mainly on four applications: In short cuts, such as small windows, vents, air conditioners, where circular wall saws' fixing takes a long time vs the required short cutting; cutting adjacent to the floor or another wall (difficult to enter with a regular circular saw); cutting thick walls, (e.g. walls of over half a meter thick in shelters and special structures); and most of all in complementary cutting for cutting with circular saws. the completion of the corners cutting, where ensuring accuracy and preventing the cutting of steel reinforcements in the walls and of the support beams, is a must.

As mentioned above, due to the current structure, the thickness of the guide bar is about 5 mm, and the thickness of the chain saw will range from 5.5 to 6 mm. This means a large cutting thickness that has three disadvantages: slow work and high-power requirements, due to the thickness, the manufacturing of a thick cut, which in many jobs is not desirable, and a mismatch to the circular wall's saws where the most popular thickness is 4.6 mm to 4.8 mm.

Those three problems significantly reduce to-date the scope of the chains' uses, especially the problem related to the need of completion a long wall cutting, in which there will be a cut widening and sometimes even going out of the permitted cutting line. Therefore, there is a need for a chain with segments' thickness of no more than 4.3 mm.

### BRIEF DESCRIPTION OF THE FIGURES

FIG. 1—is a perspective view of an existing chain saw;

FIG. 2—is a schematic illustration of a typical chain chassis 111;

FIG. 3—is a schematic illustration of an existing chain ⅜″ 104;

FIG. 3a—is a section view as taken on view A-A of FIG. 3;

FIG. 4—is a schematic illustration of the new thin chain 7/16″;

FIG. 4a—is a section view as taken on view A-A of FIG. 4;

FIG. 5—is a schematic illustration of the new thin bar nose roller (NR) 310;

FIG. 5a—is a section view as taken on view A-A of FIG. 5;

FIG. 6—is a schematic illustration view of a “peeled” blade-without the side plates;

FIG. 7—is an illustration of an existing NR 105;

FIG. 8—is one embodiment of locking the bearing in an alternative NR 310. Two illustrations from both sides are shown;

FIG. 9—is another embodiment of an alternative locking the bearing in the NR 310;

FIG. 10—is a schematic illustration of the groove′ structure for locking the new bearing structure in the NR 310;

FIG. 11—is an illustration showing the new NR's 310 inner structure and the placing of the cylindrical bearings 302 between the closing rings 300 and 301;

FIG. 12—is an illustration showing the NR 310 with an added side plate (304—with the threads) as a part of new NR 310 assembly;

FIG. 13—is an exploited illustration showing NR 310 with the other side plate 303 with riveting phases, and either screwing or riveting final process;

### DETAILED DESCRIPTION OF THE PREFERRED EMBODIMENTS

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. It is understood that the phraseology and terminology employed herein is not to be construed as limiting and are for descriptive purpose only.

The present invention relates to a special thin cutting chain saw, an adapted guide bar and a nose roller.

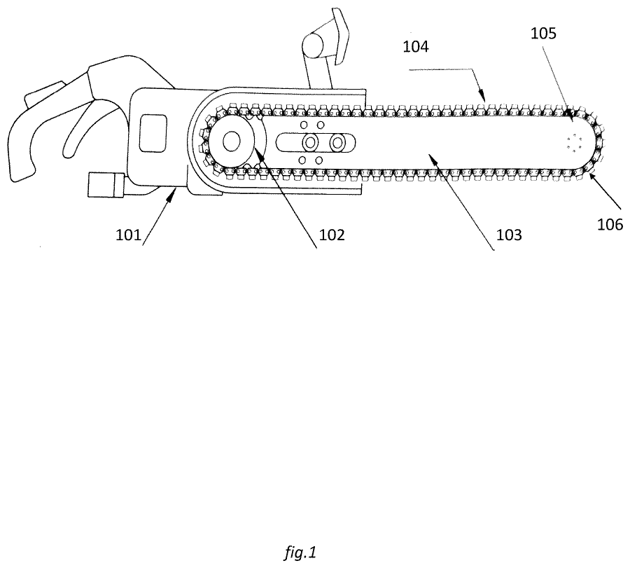

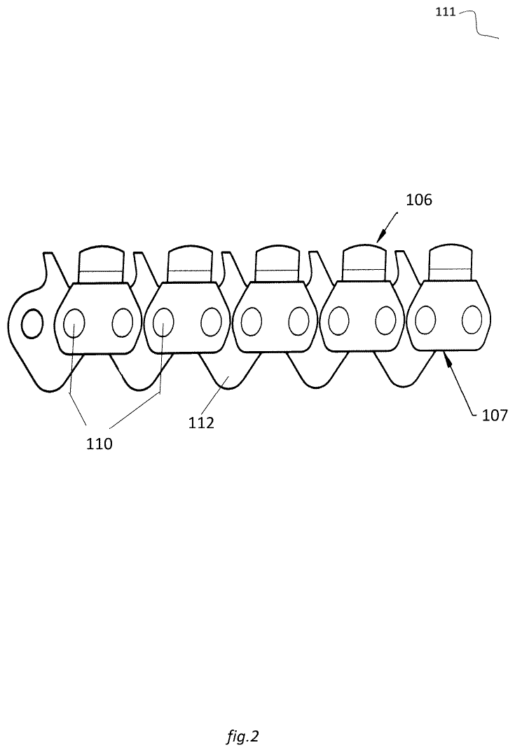

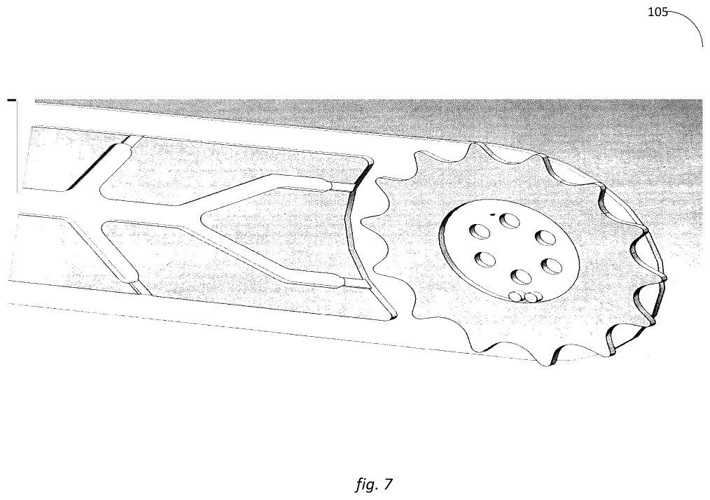

Reference is made to FIGS. 1-3 illustrating the basic structure of an existing chain saw comprising: a chain 104, a sprocket 102, a bar 103, a nose roller (NR) 105, also shown in FIG. 7, (the new NR received a new numbering 310 to avoid confusion). The chain saw is mounted on a hydraulic, gasoline or electric machine 101. Each welded chain link in the current chain comprises the following parts: two links 107, a leading tooth 112, a segment 106, 2 rings (bushings) 112 and two rivets 110.

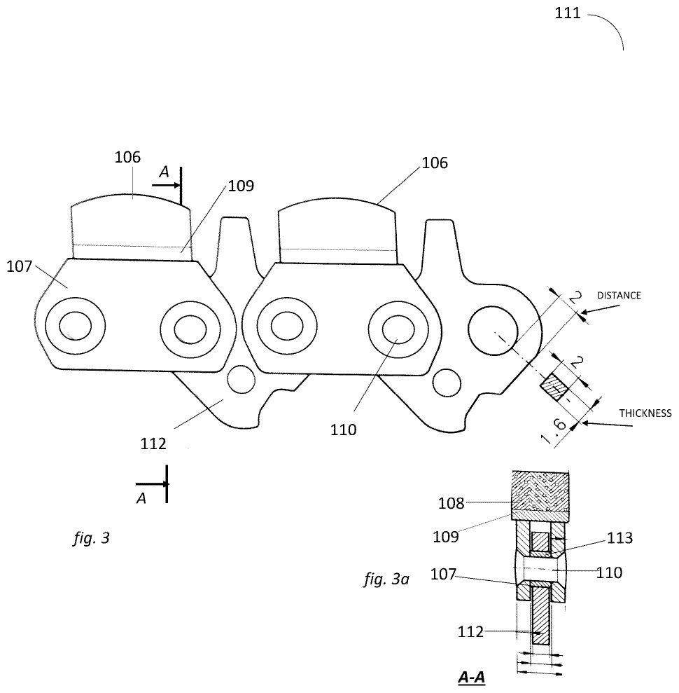

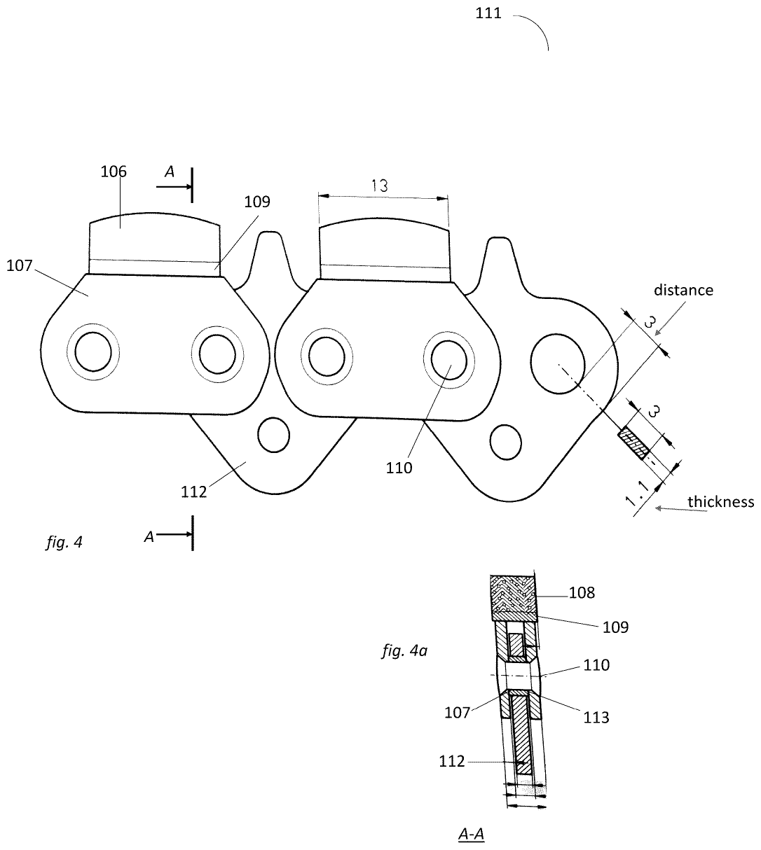

In FIG. 3, which is the basic existing structure, the distance between the hole in the leading tooth 113 and the edge of that teeth is 2 mm, and the thickness of that leading tooth is 1.6 mm, so we have a 3.2 sqmm area. In FIG. 4 we have the new leading tooth with 3 mm distance and 1.1 mm thick, giving a very similar 3.3 sqmm area.

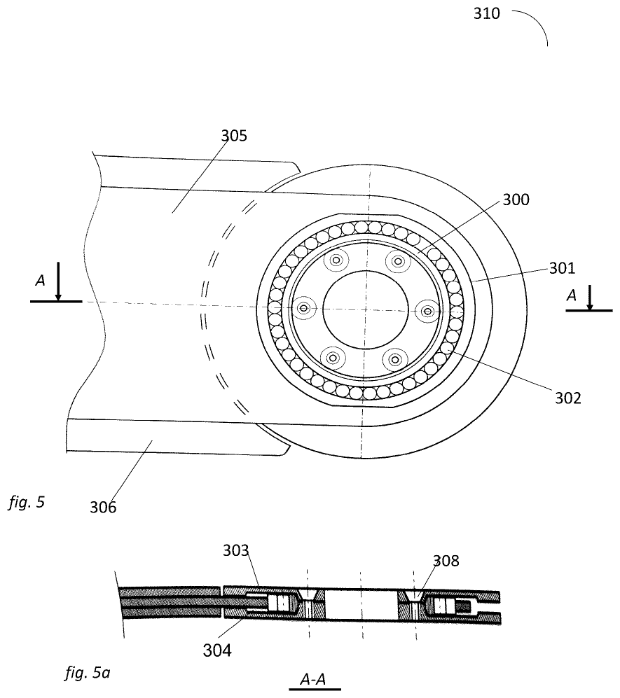

The present invention discloses a guide bar 103 with a new nose roller 310. The inventive step in the invention, beside the thickness, is the novelty of the NR 310 structure as may be seen in FIGS. 5 & 6.

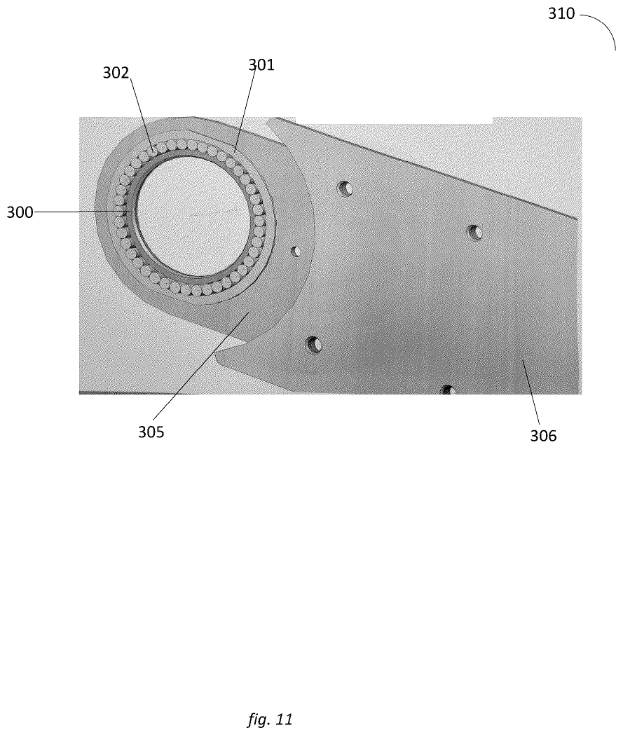

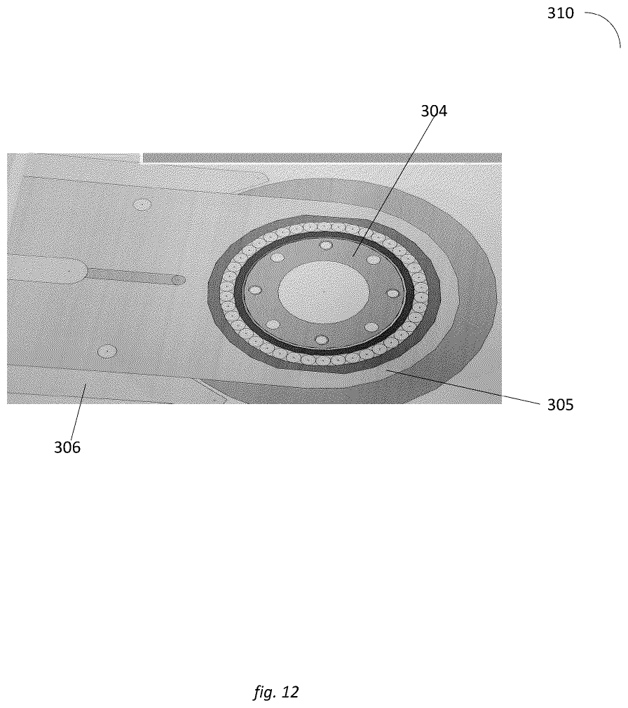

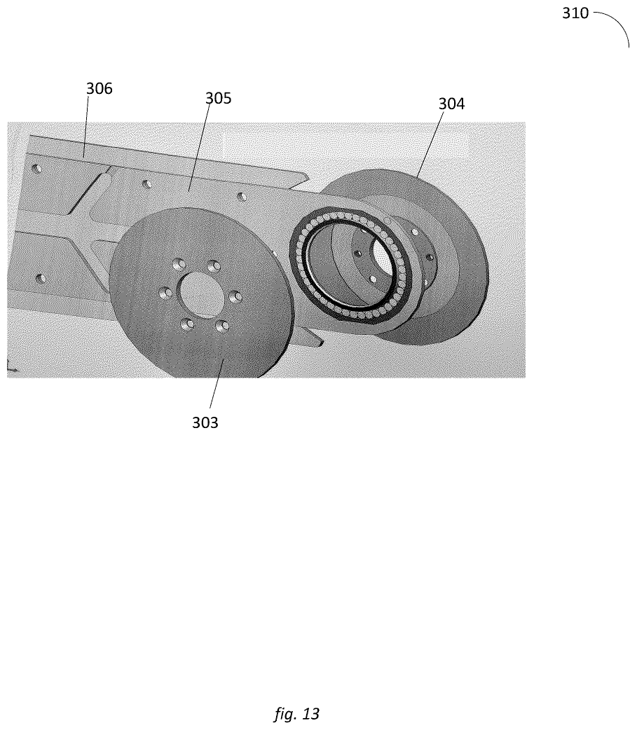

NR 310 is inserted into the round hole 313 of bar 103 with splines 314 that are located at the edge of the inner plate 305 of bar 103, as seen in FIG. 5. NR 310 comprises an inner ring 300, an outer ring 301, cylindrical bearings 302, placed in between two side plates 303 & 304, which close on cylindrical bearings 302 and on rings 300 & 301, into hole 313 and inner bar plate 305. Side plate 303 (with phases) is tightened to plate 304 (with threads) by screws or with rivets. See assembly illustrations in FIG. 11, FIG. 12 and FIG. 13.

The cylindrical bearings 302 are inserted between two rings—an inner ring 300 and an outer ring 301. The NR 310 assembly is completed by placing plate 303 at the edge and plate 304 on top of assembled NR 310 which is screwed (or riveted) into plate 303.

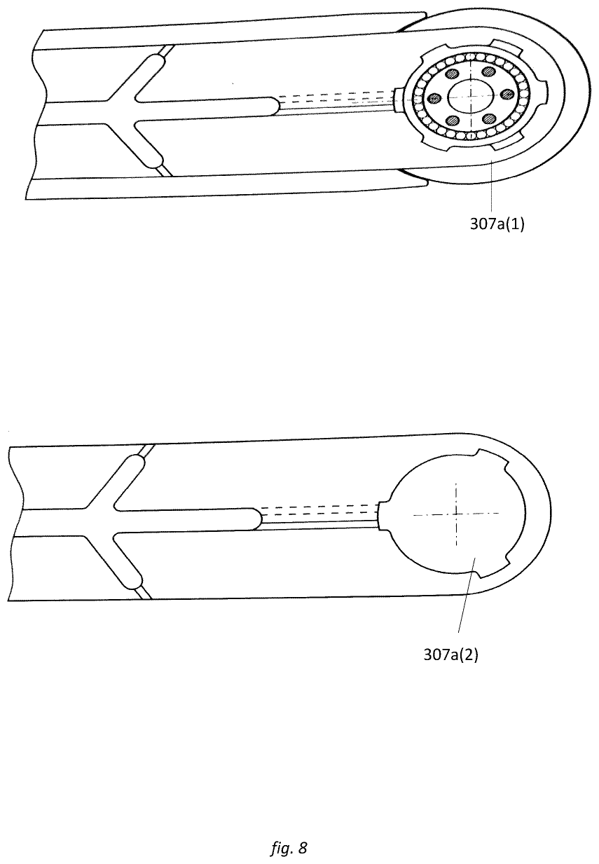

FIG. 8 illustrations 307a (1) & (2) show two sides of another alternative for closing bearings 302 of NR 310. The set of closing bearings are with 3 interlaced teeth on each side.

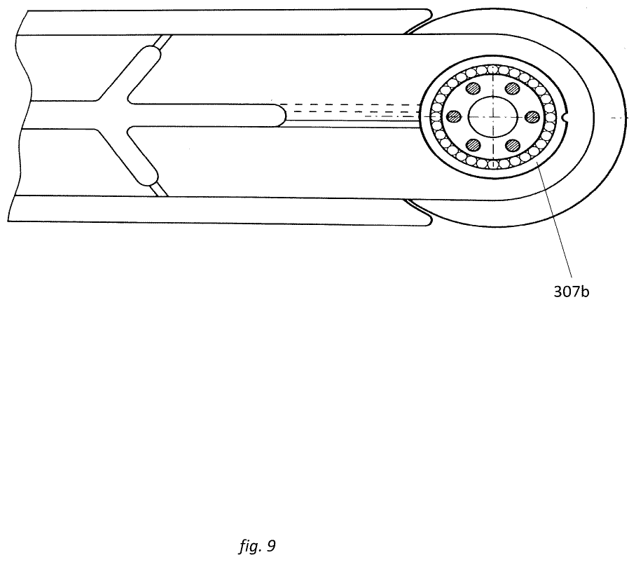

FIG. 9 307b shows another alternative for closing bearing 302 of NR 310. The set of closing bearings have a rotating stopper.

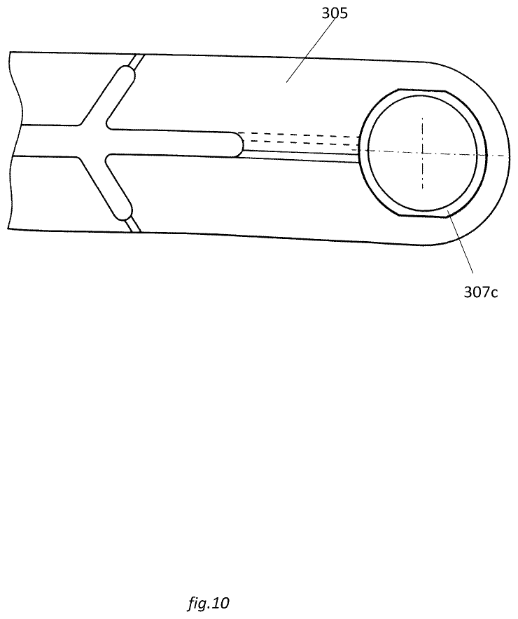

FIG. 10 307c shows the structure of the groove for the closing bearing 302 of NR 310. The set of closing bearings have two opposite splines 314, shown in FIG. 5.

The base of new bar 103, as illustrated in FIGS. 5 & 6, comprises three long plates (their length is changeable upon the length of the required bar). The two external plates 306 are solid whereas the internal plate 305 comprises a groove 309 to enable dispersing cooling water along the bar.

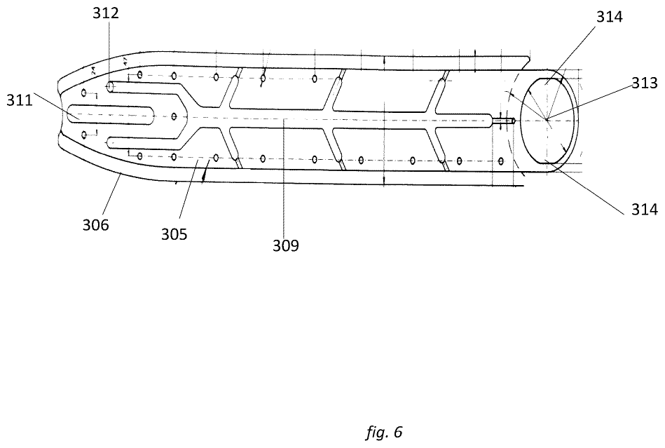

In the bar that exists today, the two side plates are long, the inner plate is shorter, and the edge of it consists of an NR 105 that the two side plates close on with rivets. Such a construction is impossible with a thinner NR. Therefore, the invention introduces a new NR 310 that sticks out as part of the inner plate 305 (see FIG. 6) and thus can keep its reduced thickness, especially when it comes to cylindrical bearings 302.

The side plates 306 are slightly wider and when riveted to the inner plate 305, create a groove all along bar 103 including the NR (with plate 303 & 304 screwed together), so that leading tooth 112 of the chain saw enters that groove and links 107 move on side plates 306 and on plates 303/304 of NR 310.

FIG. 6 shows the holes for rivets in the periphery of plates 305 and 306 (assembling the three plates together), which may also be welded, as well as groove 309 on the left (existing in all three plates), being the solution for stretching the chain on the machine, if/or when needed to be used due to some elongation of the chain.

Also, at the left end of groove 309, it shows a hole 312, through which the cooling water enter from the machine into bar 103.

The disclosed thin chain saw (FIG. 4) comprises: a diamond part of segment 106, which includes a basis 109 to enable welding, 2 rivets 110, a leading tooth 112, two links 107, and two bushings 113. Another inventive step in the invention is the thickness of leading tooth 112 and links 107.

As may be seen in FIG. 3 (existing chain) and in FIG. 4, (the new chain), the thickness of chassis 111 in FIG. 3 is 4.5 mm (Standard chain) and the thickness of chassis 111 in the new thin chain, (FIG. 4), is up to 3.4 mm. The thickness of new chassis 111 (FIG. 4) enables the usage of a thinner segment 106 (up to 4.3 mm) whereas in the existing chain (FIG. 3), the thickness of each segment 106 is between 5.5 mm to 5.7 mm.

1. A thin cutting diamond chain saw chassis, comprising a guide bar, a diamond part of segment, including a basis, two rivets, a leading tooth, two links, and two bushings;
wherein the chassis (leading tooth and links) has a thickness of up to 3.4 mm;
wherein the each segment is has a thickness of up to 4.3 mm;
wherein the guide bar comprises:
two solid side long plates,
an internal plate comprising a groove, and
a nose roller sticking out as part of the internal plate, the nose roller having a first and a second side plates;
wherein the solid side long plates are wider and when screwed or riveted together to the internal plate create a groove all along the guide bar including the nose roller, so that leading tooth enters that groove, and the links move on the solid side long plates and on the first and second nose roller side plates;
wherein the nose roller comprises an inner ring, an outer ring, cylindrical bearings inserted between an inner ring and an outer ring, placed in between the first and second nose roller side plates that close on the cylindrical bearings and on the inner and outer rings into a round hole 313 and the internal plate;
wherein the nose roller is inserted into the round hole of the guide bar with opposite splines located at an edge of the internal plate;
wherein the first nose roller side plates (with phases) is tightened to the second nose roller side plate (with threads) with screws or rivets; and
wherein a nose roller assembly is completed by placing the first nose roller side plate at the edge and the second nose roller plate on top of the nose roller assembly that is screwed (or riveted) into the first nose roller side plate.

2. The thin cutting diamond chain saw chassis of claim 1 wherein the cylindrical bearings have three interlaced teeth on each side.

3. The thin cutting diamond chain saw chassis of claim 1 wherein the cylindrical bearings have a rotating stopper.

4. (canceled)
